(19) United States
(12) Patent Application Publication
(10) Pub. No.: US 2012/0248912 A1
(43) Pub. Date: Oct. 4, 2012

(54) Magnet energized rotor apparatus

(76) Inventor: Bruce K. Ward, Hopkins, MN (US)

(21) Appl. No.: 13/199,731

(22) Filed: Sep. 7, 2011

Related U.S. Application Data
(60) Provisional application No. 61/403,179, filed on Sep. 13, 2010.

(51) Int. Cl. H02K 21/00; H02N 11/00

(52) U.S. Cl. 310/152; 74/DIG. 9

(57) ABSTRACT

A permanent magnet apparatus has coacting intercourse magnetic flux fields that cause rotation of an output shaft assembly. Permanent magnets on the output shaft assembly are located adjacent drive magnets that reciprocate to alter the magnetic flux fields. A power transmission connects the output shaft assembly to the drive magnets to coordinate the rotation of the subject shaft assembly with the reciprocating motion of the drive magnets.

### CROSS REFERENCE TO RELATED APPLICATION

This application claims the priority benefit of U.S. Patent Application Ser. No. 61/403,179 filed Sep. 13, 2010.

### FIELD OF THE INVENTION

The invention is in the field of energetics that relates to permanent magnet drive devices using magnetic flux fields to produce rotational drive forces.

### BACKGROUND OF THE INVENTION

Rotational permanent motors use magnetic propulsion to produce power for rotating a shaft. These motors have not been effective due to magnetic lock caused by interacting magnetic fields. In interacting magnetic fields, an equal amount of energy is required to enter into a magnetic field as is generated exiting the magnetic field. The result is that no useful work is achieved. Permanent magnet motors have been described in prior U.S. patents to reduce magnet lock. Examples of these permanent magnet motors are disclosed in the following U.S. patents.

H. R. Johnson in U.S. Pat. No. 4,151,431 delineates a permanent magnet motor having a plurality of permanent armature magnets fixed together in space relationship in linear or circular form. The length of the armature magnet is defined by poles of opposite polarity. The armature magnet is disposed relative to stator permanent magnets having poles of like polarity facing the stator magnets. The armature magnet is both attracted to and repelled by the adjacent opposite poles of the stator magnets. Both magnetic attraction and repulsion forces act upon the armature magnet to produce the relative displacement between the armature and stator magnets.

W. J. Lawson and R. J. Lawson in U.S. Pat. No. 4,598,221 describe and illustrate a permanent magnet motor having rockable rotor magnets to provide torque in a practical working range. The motor employs the principle of maintaining interacting substantially perpendicular rotor and stator magnet flux fields without gaps around the entire circumference of the magnet stator. The rotor magnet flux fields are rotated ninety degrees with respect to the interacting stator magnetic flux fields as the rotor magnets cross the intersections of the stator magnets. The shorter magnetic fields of the rotor magnets are contained totally within the shorter rotor magnet fields during a corner-to-corner pass across the stator magnets. This arrangement eliminates the counterproductive repulsion and attraction between the interacting magnetic flux fields.

M. T. Kadlee in U.S. Pat. No. 7,385,325 discloses a magnetic propulsion motor having a drive permanent magnet and a motion permanent magnet attached to a rotating hub. The motion magnet rotates proximate to the drive magnet. A driving force is applicable to the drive magnet to rotate to a position proximal to the motion magnet when the motion magnet is adjacent the drive magnet. This arrangement exerts a repelling force on the motion magnet as the motion magnet rotates away from the drive magnet. The rotation of the drive magnet also rotates the drive magnet to a position distal to the motion magnet as the motion magnet approaches the position proximate to the drive magnet thereby minimizing the repelling force exerted on the motion magnet by the drive magnet.

### SUMMARY OF THE INVENTION

The invention comprises a magnetic energized rotor apparatus with permanent magnets having coacting intercourse magnetic flux fields that rotates a rotor having one or more permanent output magnets to drive a power user, such as an electric generator. The apparatus has a housing accommodating an output shaft assembly. Members having bearings rotatably support the output shaft assembly for rotation about a first axis on the housing. A power transmission couples the output shaft assembly to the power user whereby on rotation of the output shaft assembly the power transmission delivers power to the power user. One or more permanent output magnets are mounted on the output shaft assembly with first magnetic flux fields generally perpendicular to the axis of the output shaft assembly. The output shaft assembly supports the permanent output magnets. Two or more additional permanent magnets attached to the outer ends of the drive magnets have magnetic flux fields that are generally perpendicular to the flux fields of the drive magnets. Magnet drive assemblies comprising one or more shafts or support beams are mounted for reciprocating movement on the housing. The shafts located adjacent the outer ends of the permanent output magnets are generally parallel to the axis of the output shaft assembly. One or more second permanent drive magnets are mounted on the shafts. Fasteners connecting the second permanent magnets to the shafts allow the permanent input magnets to reciprocate to move the input magnetic flux field about an axis perpendicular to the axis of the shafts.

The coaction of the first and second magnetic flux fields with the moving second flux field causes magnetic attraction and repulsion forces that subject the output shaft assembly to rotational forces. As the output shaft assembly rotates the input magnets reverse their positions, angles or swing whereby the polarity of the magnetic field is reversed and coacts with the opposite magnetic flux field of the first output magnets causing the output shaft assembly to continue to rotate. Permanent magnets attached to the ends of the first output magnets cause additional or extra magnetic attraction of the first output magnets resulting in more rotation thrust to the output shaft assembly. The closer the drive magnets are to the output magnets, the greater the rotational force applied to the output shaft assembly due to the coacting flux intercourse between the magnetic flux fields that results in rotation of the output shaft assembly and output magnets mounted thereon.

### DESCRIPTION OF THE DRAWING

FIG. 1 is a diagram of the magnet energized rotor apparatus of the invention coupled to an electric generator and a battery;

FIG. 2 is a top plan view of the magnet energized rotor apparatus of FIG. 1;

FIG. 3 is an enlarged sectional view taken along line 3-3 of FIG. 2;

FIG. 3A is a sectional view according to FIG. 3 showing the walking beam in a clockwise position;

FIG. 3B is a sectional view according to FIG. 3 showing the walking beam in a counter clockwise position;

FIG. 4 is a sectional view taken along line 4-4 of FIG. 3;

FIG. 5 is an enlarged sectional view taken along line 5-5 of FIG. 3;

FIG. 6 is an enlarged sectional view taken along line 6-6 of FIG. 3;

FIG. 7 is an enlarged sectional view taken along line 7-7 of FIG. 3;

FIG. 8 is an enlarged sectional view taken along line 8-8 of FIG. 3;

FIG. 9 is an enlarged sectional view taken along line 9-9 of FIG. 3;

FIG. 10 is an enlarged sectional view taken along line 10-10 of FIG. 3;

FIG. 11 is a sectional view according to FIG. 3 of a first modification of the magnet energized rotor apparatus of the invention; and

FIG. 12 is a sectional view according to FIG. 3 of a second modification of the magnet energized rotor apparatus of the invention.

### DESCRIPTION OF THE INVENTION

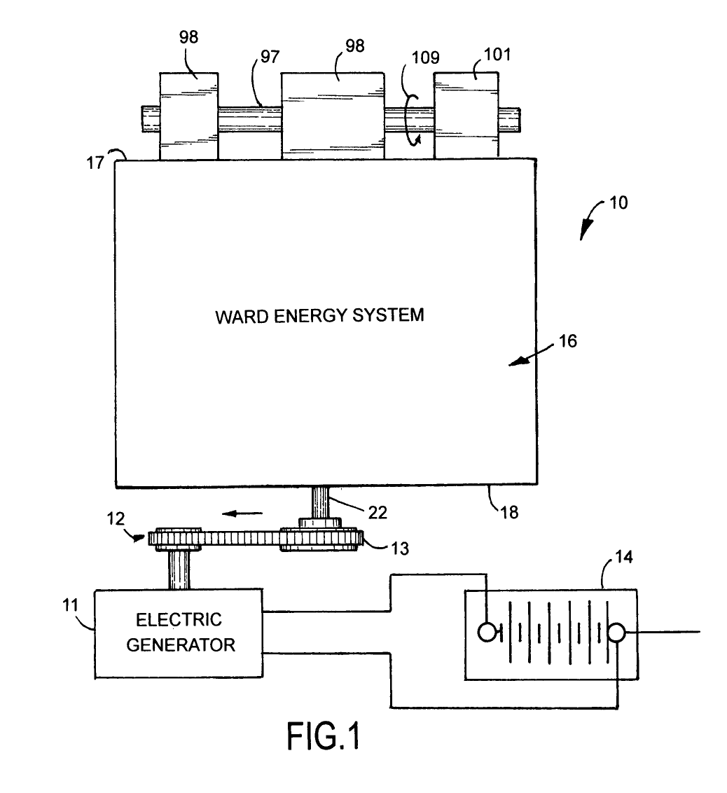

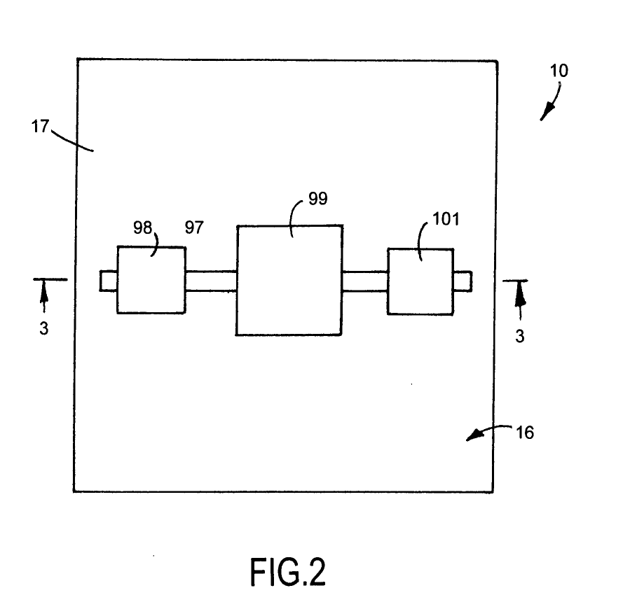

The magnet energized rotor apparatus 10, shown in FIG. 1, is operatively coupled to a power user 11, shown as an electric generator wired to a battery 14. Power user 11 can be a fluid pump, a hydraulic operated motor or other devices driven by apparatus 10. A power transmission 12 comprising an endless chain and sprocket drive 13 operates to transfer mechanical power from output shaft 22 of output shaft assembly 21 to power user 11. Power transmission 12 can be a belt and pulley drive, gear drive or a magnetic coupling.

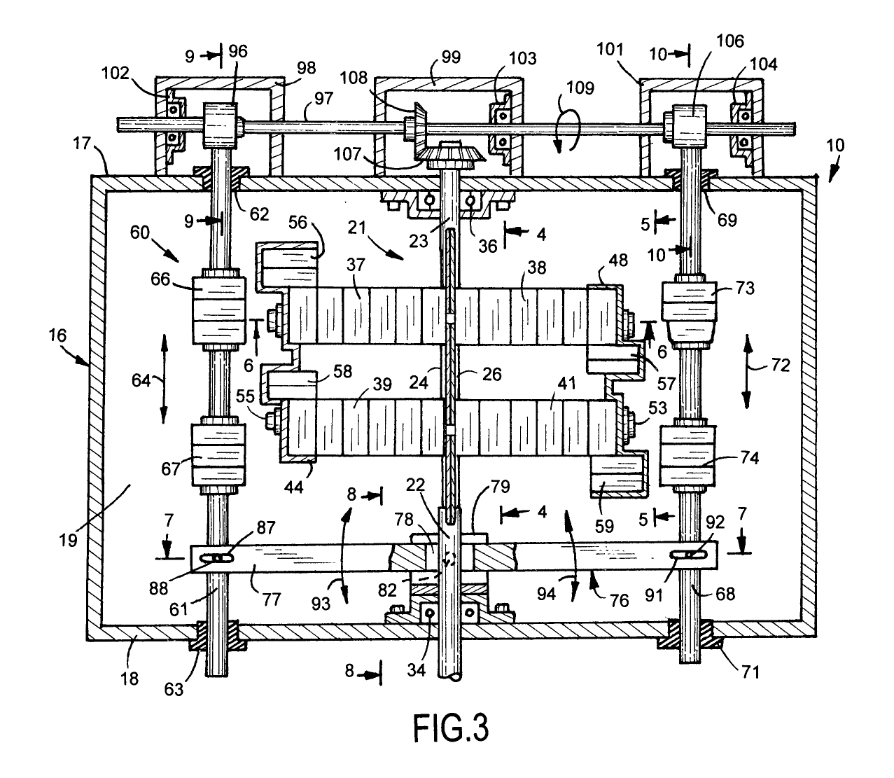

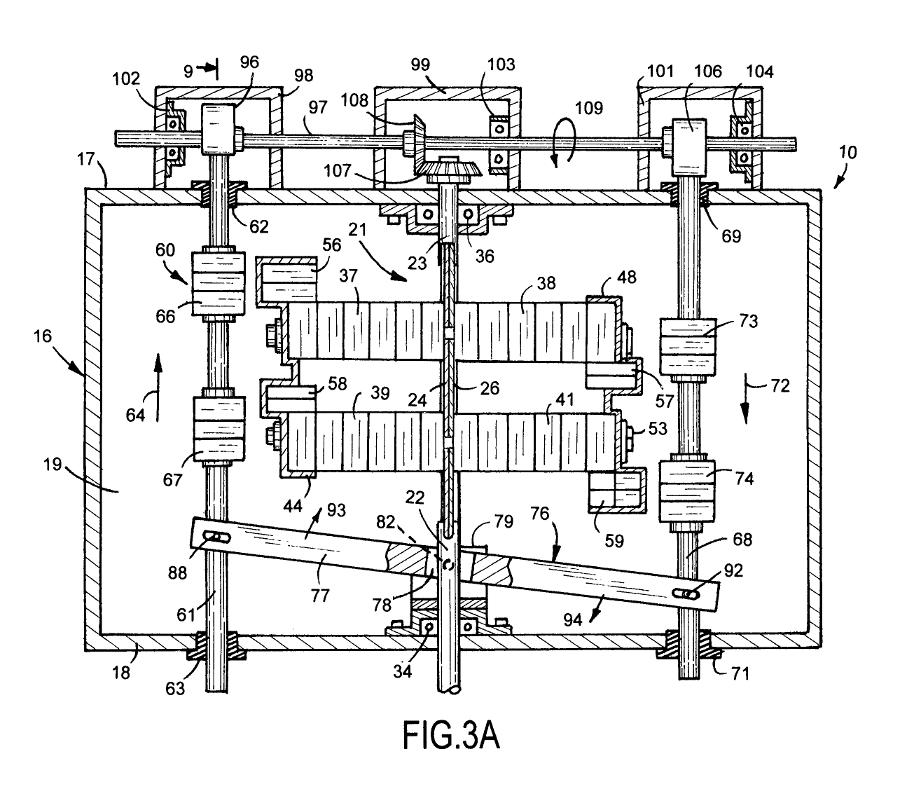

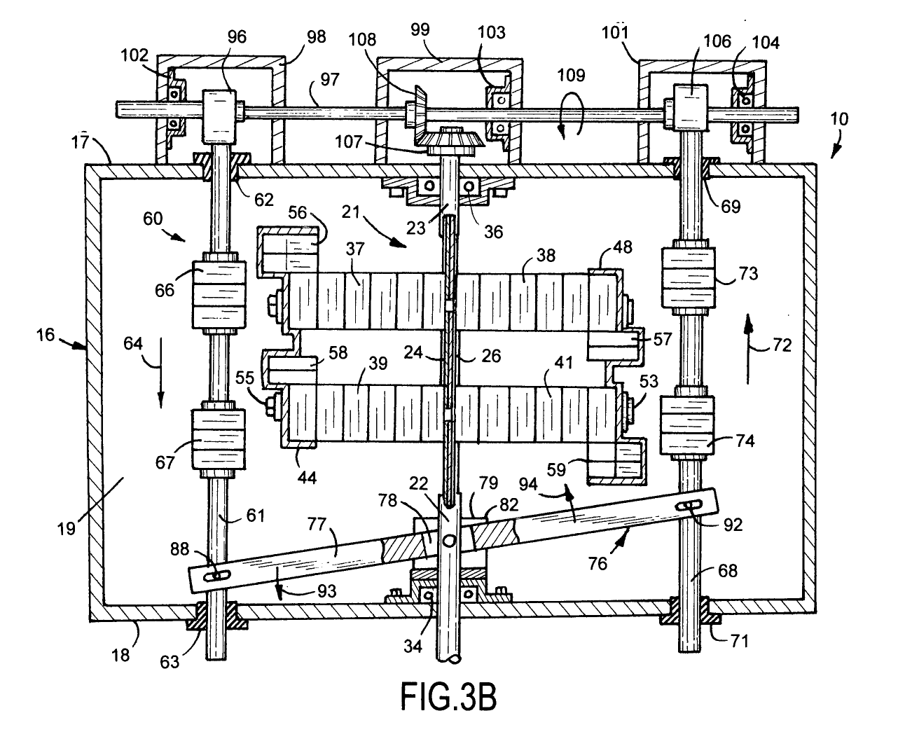

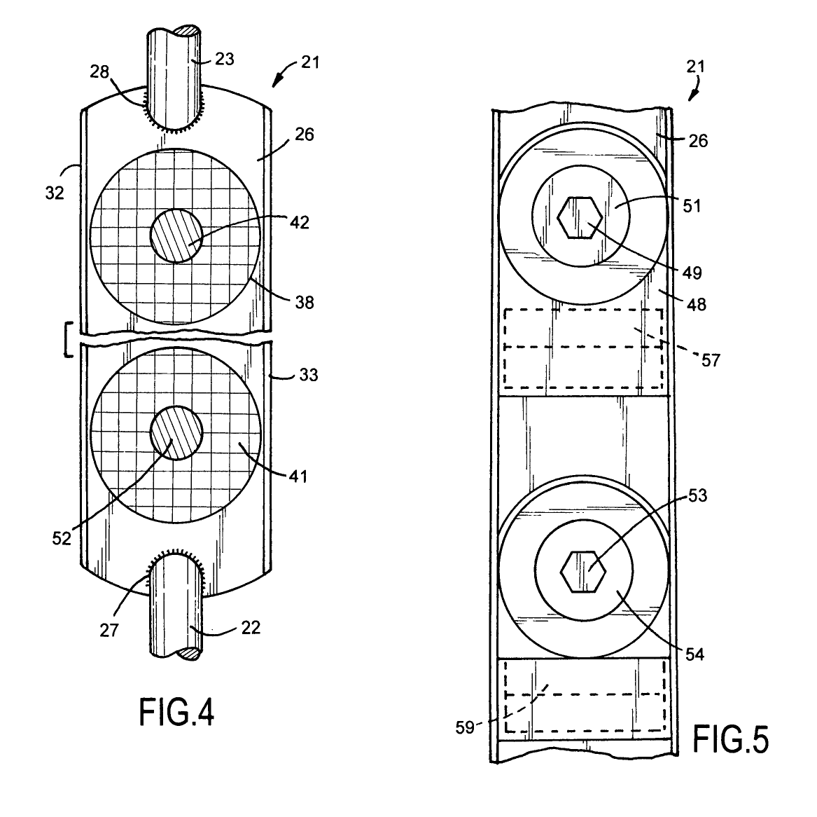

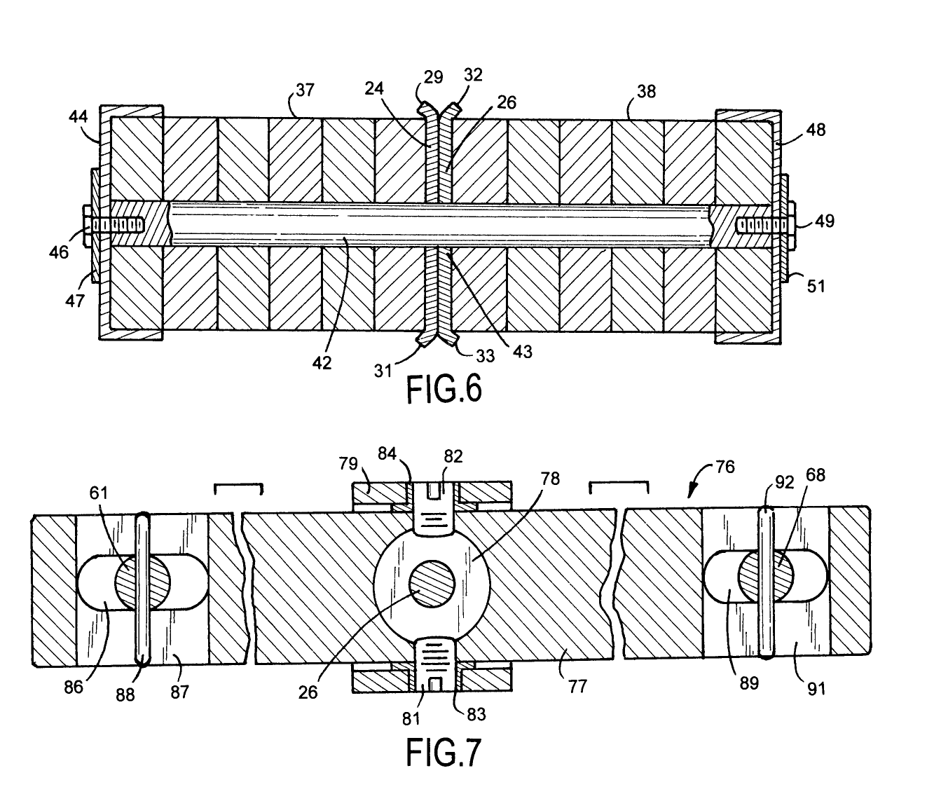

As shown in FIG. 3, magnet energized apparatus 10 has a housing 16 including a horizontal top wall 17 and a horizontal bottom wall 18. Housing 16 encloses an interior chamber 19 containing an output shaft assembly 21 and an input shaft assembly 60. Output shaft assembly 21 has downwardly extended vertical lower shaft 22 mounted on bottom wall 18 with a bearing 34. An upwardly extending vertical upper shaft 23 is mounted on top wall 17 with a bearing 36. A pair of side-by-side flat plates 24 and 26 extend between and are secured with welds 27 and 28 to shafts 22 and 23. As shown in FIGS. 4 and 6, plates 24 and 26 have side flanges or ribs 29, 31, 32 and 33 which increase the bending strength of the plates. Plates 24 and 26 can be a one-piece plate.

A first series of side-by-side output magnets 37 and 38 are located adjacent opposite sides of plates 24 and 26. Output magnets 37 and 38 are toroidal or doughnut-shaped permanent magnets, such as hardened steel and its Alnico alloys. The permanent magnets can be neodymium rare earth magnets. A second series of side-by-side output magnets 39 and 41 are located adjacent opposite sides of plates 24 and 26 below the first series of magnets 37 and 38. As shown in FIG. 6, magnets 37 and 38 each comprise an array of magnets, shown as six magnets. The number of magnets can vary from one magnet to a selected number of magnets. A linear rod 42 of non-magnetic material extends through magnets 37 and 38 and holes 43 in plates 24 and 26. A first cover 44 is retained on the end magnet with a bolt 46 threaded into an end of rod 42. Bolt 46 bears against a washer 47 engageable with cover 44. A second cover 48 is retained on magnet 38 with a bolt 49 threaded into an end of rod 42. A washer 51 disposed between cover 48 and bolt 49 bears against magnet 38. Bolts 46 and 49 clamp magnets 37 and 38 on plates 37 and 38. A second series of side-by-side output magnets 39 and 41 are mounted on plates 24 and 26 below output magnets 37 and 38. Magnets 39 and 41 have the same permanent magnet structure and rod as shown in FIG. 6. Bolts 53 and 55 thread into the opposite ends of the rod retain covers 44 and 48 on the opposite ends of output magnets 39 and 41. Covers 44 and 48 have middle sections that laterally space the first and second series of output magnets 37, 38 and 39, 41. Additional series of output magnets can be mounted on plates 24 and 26.

As shown in FIG. 3, additional magnets 56 and 57 are mounted on the sides of opposite ends of magnets 37 and 38. The flux fields of magnets 56 and 57 are perpendicular to the flux fields of magnets 37 and 38. The axes of magnets 56 and 57 are parallel to the axis of rotation of output shaft assembly 21. The outside faces of magnets 37, 38, 56 and 57 have positive or north polarity. Additional magnets 58 and 59 are mounted on the sides of the outer ends of magnets 39 and 41. The flux fields of magnets 58 and 59 are perpendicular to the flux fields of magnets 39 and 41. The axes of magnets 58 and 59 are parallel to the axis of rotation of output shaft assembly 21. The outside faces of magnets 39, 41, 58 and 59 have positive or north polarities.

A drive mechanism 60 having a plurality of permanent magnets 66, 67, 73 and 74, shown in FIG. 3, have flux fields that have coacting intercourse with the flux fields of magnets 37, 38, 39 and 41 that results in rotation of output shaft assembly 21 and magnets 37, 38, 39 and 41 mounted thereon. Drive mechanism 60 includes upright shafts or beams 61 and 68 supporting magnets 66, 67, 73 and 74 in close relationship relative to the outer ends of magnets 37, 38, 39 and 41. Bearings 62 and 63 mount shaft 61 on housing walls 17 and 18 for reciprocating movement shown by arrow 64. Bearings 69 and 71 mount shaft 68 on housing walls 17 and 18 for reciprocating movement shown by arrow 72. The reciprocating axes of shafts 61 and 68 are parallel to the axis of rotation of output shaft assembly 21.

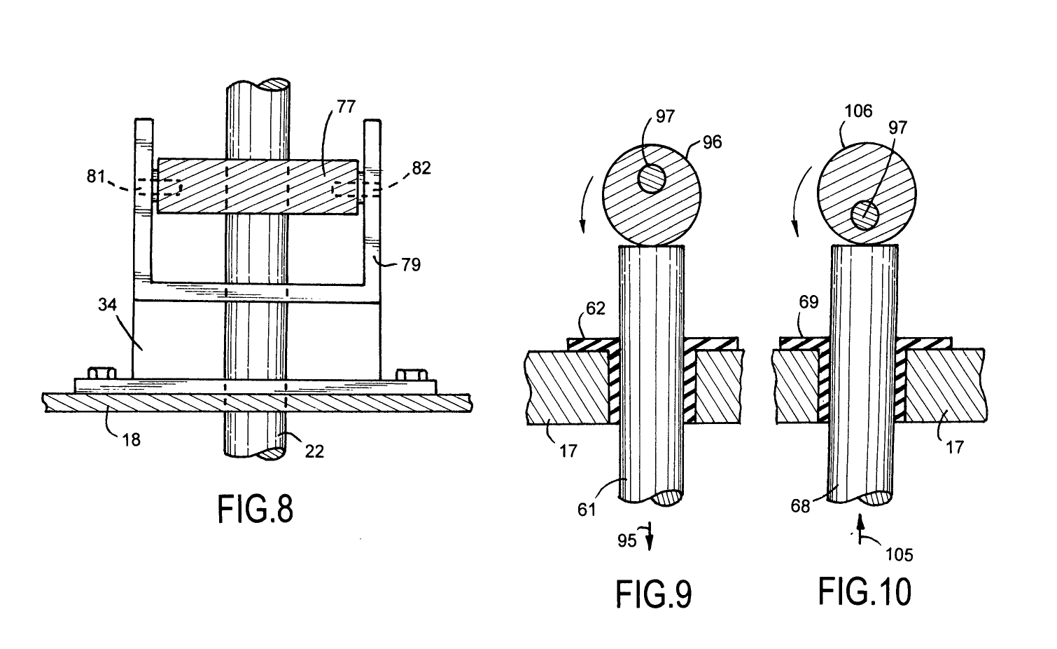

A walking beam 76, shown in FIGS. 3, 3A and 3B, coordinates the reciprocating movements of shafts 61 and 68 in opposite directions. Walking beam 76 comprises a rigid bar 77 having a center hole 78 for shaft 22. As shown in FIG. 8, a U-shaped support or mount 79 attached to bearing 34 or bottom wall 18 accommodate pivot members 81 and 82 that pivotally connect bar 77 to support 79 for rocking or swinging movement as shown by arrows 93 and 94. Walking beam 76, shown in clockwise and counter clockwise positions in FIGS. 3A and 3B, operates in conjunction with cams 96 and 106 to reciprocate drive magnets 66, 67, 73 and 74 relative to output magnets 37, 38, 39 and 41. As shown in FIG. 7, bearings 83 and 84 rotatably mount pivot members 81 and 82 on support 79. Other types of pivot structures can be used to pivotally mount bar 77 on housing 16. As shown in FIGS. 3 and 7, shaft 61 is operatively connected to an end of bar 77 with a lost motion connection comprising a vertical slot 86 and a horizontal slot 87. Shaft 61 extends through slot 86. A horizontal pin 88 joined to shaft 61 extends through slot 87. Slots 86 and 87 and pin 88 allow bar 77 to swing and move shaft up and down as shown by arrow 64. The opposite end of bar 77 has a lost motion connection comprising a vertical slot 89 and horizontal slot 91. Shaft 68 extended through slot 89 accommodates a horizontal pin 92 positioned in slot 91. Slots 89 and 91 and pin 92 allows bar 77 to swing and move shaft up and down as shown by arrow 72. Other types of motion devices, such as slots and rollers, can be used to operatively connect bar 77 to shafts 61 and 68. The swinging movements of bar 77 are shown by arrows 93 and 94 in FIGS. 3, 3A and 3B.

The reciprocating or up and down movements of shafts 61 and 68 are generated by cams 96 and 106 secured to a shaft 97. Cams 96 and 106 have working profiles that have uniformly accelerated and retarded motion causing a gradual change in velocity of shafts 61 and 68 to inhibit shock when direction of motion changes. Bearings 102, 103 and 104 rotatably mount shaft 97 on supports or housings 98, 99 and 101. As shown in FIG. 9, cam 96 engages the upper end of shaft 61. On rotation of shaft 97, cam 96 pushes shaft 61 and magnets 66 and 67, as shown by arrow 95. This changes the flux field coacting relationship between magnet 66 and magnet 37 and magnet 67 and magnet 39 resulting in magnet flux fields that cause output shaft assembly 21 and magnets 37, 38, 39 and 41 mounted thereon to rotate thereby transmitting power to power user 11. As shown in FIG. 10, cam 106 engages the upper end of shaft 68 and allows shaft 68 to move in an upward direction, as shown by arrow 105. Cams 96 and 106 along with bar 77 alternatively reciprocate shafts 61 and 68 and magnets 66, 67, 73 and 74 mounted thereon.

Shaft 97 is drivably coupled to output shaft assembly 21 with a pair of bevel gears 107 and 108. Bevel gear 107 is connected to shaft 23 of output shaft assembly 21. Bevel gear is attached to shaft 97 whereby rotation of output shaft assembly 21 rotates shaft 97 and cams 96 and 106, shown by arrow 109, which results in reciprocation of shafts 61 and 68 and magnets 66, 67, 73 and 74. Other types of power transmissions can be used to drivably connect output shaft assembly 21 to cams 96 and 106 to reciprocate shafts 61 and 68 and drive magnets 66, 67, 73 and 74. The power transmissions including gears 107 and 108 and shaft 97 results in a harmonious combination or interaction between the rotational speed of output shaft assembly 21 and the reciprocating movement of shafts 61 and 68 and drive magnets 66, 69, 73 and 74. The reciprocating movements of drive magnets 66, 69, 73 and 74 is coordinated with the rotational positions of output magnets 37, 38, 39 and 41 to establish the coacting intercourse magnetic flux fields that rotates the output drive assembly 21 to supply power to electric generator 11.

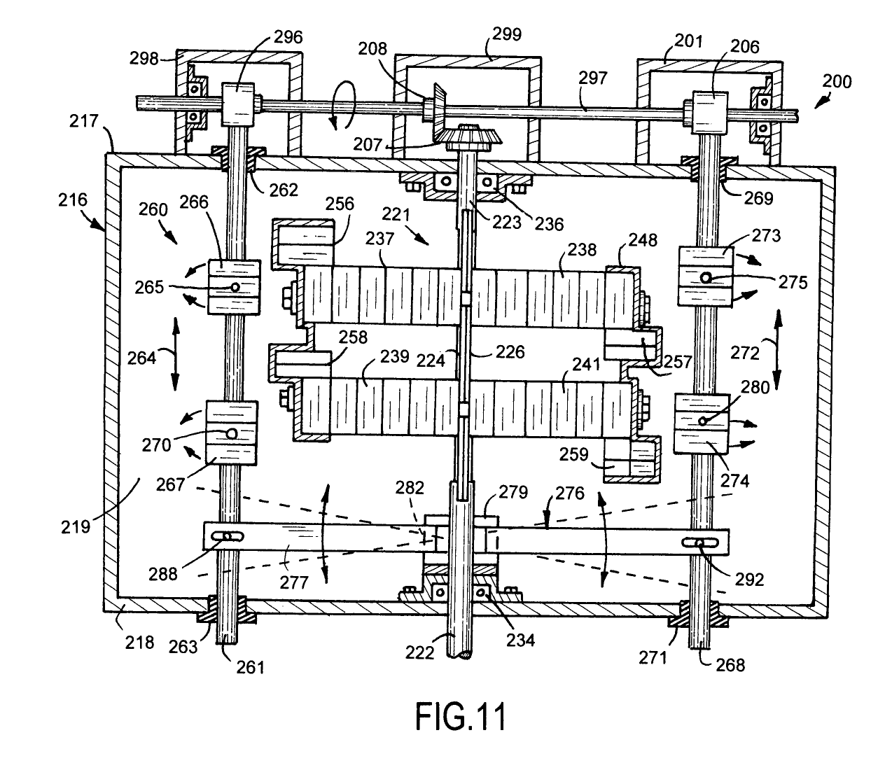

A first modification of the magnet energized rotor apparatus 200, shown in FIG. 11, has parts and operating functions that agree with the parts and functions of apparatus 10 shown in FIG. 3. The structures of FIG. 11 that are the same as the structures of FIG. 3 have the same reference numbers with the prefix 2 and are incorporated herein. Magnets 266 and 267 are pivoted to shaft 261 with horizontal pivot members 265 and 270 for swing movements about axes perpendicular to shaft 261. The magnetic flux fields of magnets 266 and 267 move up and down and angularly shift relative to the magnetic flux fields of magnets 237, 256 and 239, 258 which results in rotation of output shaft assembly 221 and magnets 237, 238 and 239, 241 mounted thereon. Magnets 273 and 274 are pivoted to shaft 268 with pivot members 275 and 280 for swinging movements about axes perpendicular to shaft 268. The magnetic flux fields of magnets 273 and 274 angularly shift relative the magnet flux fields of magnets 238, 257 and 241, 259 to also result in rotation of output shaft assembly 221 and magnets 237, 238, 239 and 241 mounted thereon. The magnetic flux fields of magnets 266, 267, 273 and 274 do not align with the magnetic flux fields of magnets 237, 238, 239 and 241 thereby inhibiting lock up of output shaft assembly 221.

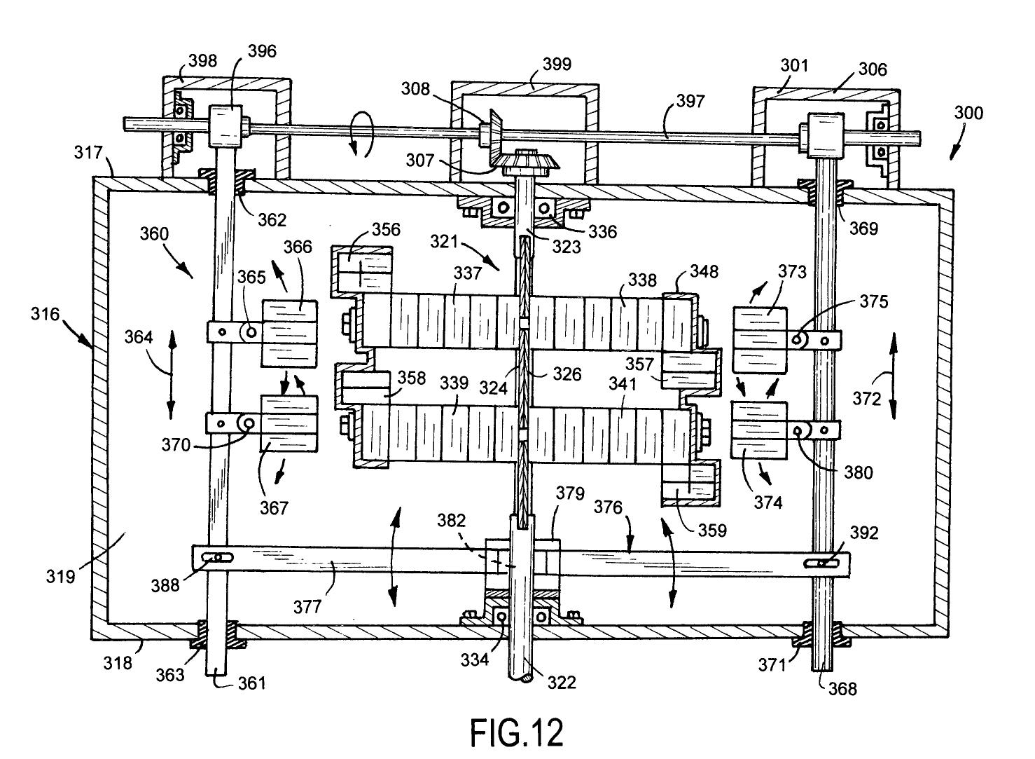

A second modification of the magnet energized rotor apparatus 300, shown in FIG. 12, has parts and operating functions that correspond to the parts and functions of apparatus 10 shown in FIG. 3. The structures of FIG. 12 that are the same as the structures of FIG. 3 have the same reference number with the prefix 3 and are incorporated herein. Magnets 366 and 367 located between shaft 361 and the outer ends of magnets 337 and 339 are pivotally connected to shaft 361 with pivot members 365 and 370. Pivot members 365 and 370 allow magnets 366 and 367 to swing or pivot about axes that are perpendicular to the rotating axis of output shaft assembly 321. Cam 396 engages shaft 361 and moves shaft 361 downward. Walking beam 377 operates to move shaft 361 upwardly whereby shaft 361 and magnets 366 and 367 reciprocates as shown by arrow 364. The magnetic flux fields of magnets 366 and 367 move up and down and angularly shift relative to the magnetic flux fields of magnets 337 and 339 which results in rotation of output shaft assembly 321 and magnets 337, 338, 339 and 341 mounted thereon. The magnetic flux fields of magnets 366 and 367 do not align with the magnetic flux fields of magnets 337, 339, 356 and 358 thereby inhibiting lock up of output shaft assembly 321. Magnets 373 and 374 located between shaft 368 and magnets 338 and 341 are pivotally connected to shaft 368 with pivot members 375 and 380. Pivot members 375 and 380 allow magnets 373 and 374 to swing or pivot about axes that are perpendicular to the rotating axis of output shaft assembly 321. The magnetic flux fields of magnets 373 and 374 do not align the magnetic flux fields of magnets 338, 341, 357 and 359 thereby also inhibiting lock up of output shaft assembly 321.

A summation of the energized rotor apparatus 10 for generating output power consists of output shaft assembly 21 supported with bearings 34 and 36 on housing 16. A power transmission 12 couples output shaft assembly 21 to a power user 11, shown as an electric generator. The output shaft assembly 21 supports one or more series of drive magnets 37 and 38 which are attached perpendicular to each side of output shaft assembly 21. Two or more permanent magnets 56 and 57 are attached perpendicular to the outer ends of drive magnets. Input magnet assembly 60 consists of one or more shafts or beams 61 and 68 supporting one or more input magnets 66, 67, 73 and 74. The input magnets 66, 67, 73 and 74 are positioned perpendicular to the outer faces of drive magnets 37 and 38. The input magnet assembly 60 is capable of angular reciprocating motion or up and down motion. The coacting magnetic flux fields of the input magnets and drive magnets exerts a force on output shaft assembly 21 causing rotation of the output shaft assembly 21 and operation of the power user 11. The closer the input magnets 67, 68, 73 and 74 are to drive magnets 37, 38, 39 and 41, results in increased or greater coacting flux forces and thrust to output shaft assembly 21. The magnets 56, 57, 58 and 59 attached to the ends of the drive magnets 37, 38, 39 and 41 cause extra attraction of the input magnets 66, 67, 73 and 74 giving more thrust to output shaft assembly 21.

In one embodiment of the energized rotor apparatus 200, the input magnets 266, 267, 273 and 274 angularly move relative to the faces of drive magnets 237, 238, 239 and 241 causing a magnetic attraction and rotation of output shaft assembly 221. As the output shaft assembly 221 rotates the input magnet sides angularly move whereby the polarity is reversed and the opposite flux field of the drive magnets 237, 238, 239 and 241 will continue their attraction or pull and rotation of output shaft assembly 221.

The invention includes rotatable “output shaft” with permanent output magnets centered and attached perpendicular thereon with 1, 2 or more permanent magnets attached perpendicular to the top or bottom of each end of the output magnets.

Next we have one or more “input shafts” with permanent input magnets centered thereon diagonally or perpendicular to and in alignment with “output magnets” faces.

A one-half rotation of the “output magnets” will cause their faces and side to reverse their respective positive magnetic fields position and cause the stationary “input shafts” with their reciprocating negative magnetic faces to reverse and move to a perpendicular or diagonal position when drawn to the opposite positive face of the “output shafts” magnets. This causes the “output shaft” to continue its rotation.

The energized rotor apparatus has been shown and described in several embodiments. It is understood that changes in structures and arrangements of structures including permanent magnets can be made by persons skilled in the art without departing from the invention.

1. A permanent magnet drive apparatus comprising:
a housing,
an output shaft assembly having a first axis,
first members rotatably mounting the output shaft assembly on the housing for rotation about the first axis,
a plurality of first permanent magnets mounted on the output shaft assembly having outwardly directed first magnetic flux fields generally perpendicular to the first axis,
at least one input shaft assembly having a second axis located generally parallel to the first axis of the output shaft assembly,
second members mounting the input shaft assembly on the housing for movement along the second axis,
a drive operable to reciprocate the input shaft assembly along said second axis,
one or more second permanent magnets mounted on the input shaft assembly having a moving second magnetic flux field that interacts with the first magnetic flux fields to cause the output shaft assembly to rotate about the first axis,
a pivot member mounting the second permanent magnets on the input shaft assembly for angular movement about a third axis generally perpendicular to the second axis whereby the second magnetic flux field has interacting intercourse with the first magnetic flux field to cause the output shaft assembly to rotate about the first axis,
a bar pivoted on the housing connected to the one input shaft assembly moveable in response to reciprocation of the input shaft assembly, and
a power transmission operatively connected to the output shaft assembly for transmitting power from the output shaft assembly to a power user.

2. The apparatus of claim 1 wherein:
the output shaft assembly includes at least one member for supporting the first permanent magnets.

3. The apparatus of claim 1 wherein:
the first members include bearings rotatably mounting the output shaft assembly on the housing.

4. The apparatus of claim 1 wherein:
the first permanent magnets comprise a series of face-by-face permanent magnets.

5. The apparatus of claim 1 including:
third permanent magnets mount on the first permanent magnets having magnetic flux fields generally perpendicular to the first magnetic flux fields of the first permanent magnets.

6. The apparatus of claim 1 including:
a plurality of input shaft assemblies,
each input shaft assembly having a second axis generally parallel to the first axis of the output shaft assembly,
said second permanent magnets being mounted on each of the input shaft assemblies,
drives operable to reciprocate each of said input shaft assemblies, and
a walking beam pivotally mounted on the housing connected to the input shaft assemblies moveable in response to reciprocation of said input shaft assemblies.

7. The apparatus of claim 1 including:
power transmitting members connecting the output shaft assembly to the input shaft assembly whereby rotation of the output shaft assembly causes movement of the input shaft assembly along the second axis and movement of the second permanent magnets relative to the first permanent magnets.

8. A permanent magnet drive apparatus comprising:
a housing,
an output shaft assembly having a first axis,
first members rotatably mounting the output shaft assembly on the housing for rotation about the first axis,
a first permanent magnet mounted on the output shaft assembly having an outwardly directed first magnetic flux field generally perpendicular to the first axis,
at least one input shaft assembly having a second axis located generally parallel to the first axis of the output shaft assembly,
second members mounting the input shaft assembly on the housing,
one or more second permanent magnets mounted on the input shaft assembly having a second magnetic flux field that interacts with the first magnetic flux fields to cause the output shaft assembly to rotate about the first axis, and
a third member operatively connecting the output shaft assembly to a power user.

9. The apparatus of claim 8 wherein:
the output shaft assembly includes a rod for supporting the first permanent magnet.

10. The apparatus of claim 8 wherein:
the first members include bearings rotatably mounting the output shaft assembly on the housing.

11. The apparatus of claim 8 including:
third permanent magnets mount on the first permanent magnet having magnetic flux fields generally perpendicular to the first magnetic flux field of the first permanent magnet.

12. The apparatus of claim 8 including:
a plurality of input shaft assemblies,
each input shaft assembly having a second axis generally parallel to the first axis of the output shaft assembly, and
said second permanent magnets being mounted on each of the input shaft assemblies.

13. The apparatus of claim 8 including:
power transmitting members connecting the output shaft assembly to the input shaft assembly whereby rotation of the output shaft assembly causes movement of the input shaft assembly along its axis and movement of the second permanent magnets relative to the first permanent magnets.

14. The apparatus of claim 8 including:
a pivot member mounting the second permanent magnet on the input shaft assembly for angular movement about a third axis generally perpendicular to the second axis whereby the second magnetic flux field interacts with the first magnetic flux field to cause the output shaft assembly to rotate about the first axis.

15. The apparatus of claim 8 including:
a drive operable to reciprocate the input shaft assembly along said second axis, and
a bar pivoted on the housing connected to the one input shaft assembly moveable in response to reciprocation of the one input shaft assembly.

16. The apparatus of claim 8 including:
a pair of input shaft assemblies,
members mounting said second permanent magnets on the input shaft assemblies,
drives operable to reciprocate the input shaft assemblies in opposite directions along the second axis of each input shaft assembly, and
a walking beam pivotally mounted on the housing connected to the input shaft assemblies moveable in response to reciprocation of said input shaft assemblies.

17. A permanent magnet drive apparatus comprising:
a housing,
an output shaft assembly having a first axis,
first members rotatably mounting the output shaft assembly on the housing for rotation about the first axis,
a plurality of first permanent magnets mounted on the output shaft assembly having outwardly directed first magnetic flux fields generally perpendicular to the first axis,
at least one input shaft assembly having a second axis located generally parallel to the first axis of the output shaft assembly,
second members mounting the input shaft assembly on the housing for movement along the second axis,
a drive operable to reciprocate the input shaft assembly along said second axis,
one or more second permanent magnets mounted on the input shaft assembly having a moving second magnetic flux field that interacts with the first magnetic flux fields to cause the output shaft assembly to rotate about the first axis,
a bar pivoted on the housing connected to the one input shaft assembly moveable in response to reciprocation of the input shaft assembly, and
a bar pivoted on the housing connected to the one input shaft assembly moveable in response to reciprocation of the input shaft assembly, and
a power transmission operatively connected to the output shaft assembly for transmitting power from the output shaft assembly to a power user.

18. The apparatus of claim 17 wherein:
the output shaft assembly includes at least one member for supporting the first permanent magnets.

19. The apparatus of claim 17 wherein:
the first members include bearings rotatably mounting the output shaft assembly on the housing.

20. The apparatus of claim 17 wherein:
the first permanent magnets comprise a series of face-by-face permanent magnets.

21. The apparatus of claim 17 including:
third permanent magnets mount on the first permanent magnets having magnetic flux fields generally perpendicular to the first magnetic flux fields of the first permanent magnets.

22. The apparatus of claim 17 including:
a plurality of input shaft assemblies,
each input shaft assembly having a second axis generally parallel to the first axis of the output shaft assembly,
said second permanent magnets being mounted on each of the input shaft assemblies,
drives operable to reciprocate each of said input shaft assemblies, and
a walking beam pivotally mounted on the housing connected to the input shaft assemblies moveable in response to reciprocation of said input shaft assemblies.

23. The apparatus of claim 17 including:
power transmitting members connecting the output shaft assembly to the input shaft assembly whereby rotation of the output shaft assembly causes movement of the input shaft assembly along the second axis and movement of the second permanent magnets relative to the first permanent magnets.
